(19) United States
(12) Patent Application Publication
(10) Pub. No.: US 2009/0058756 A1
(43) Pub. Date: Mar. 5, 2009

(54) Antenna supporter, antenna assembly and machine having the antenna assembly

(76) Inventors: WEN-CHIA KUO, Shueishang Township (TW); Chia-Ching Su, Sanchong City (TW); Ming-Tsai Wang, Beigang Township (TW)

Correspondence Address: HDLS Patent & Trademark Services, P.O. BOX 220746, CHANTILLY, VA, 20153-0746, US

(21) Appl. No.: 11/937,408

(22) Filed: Nov. 8, 2007

(30) Foreign Application Priority Data
Aug. 31, 2007 (TW) 096132400

(51) Int. Cl. H01Q 1/22

(52) U.S. Cl. 343/878

(57) ABSTRACT

An antenna supporter is for being installed on a machine. The machine is to execute an operation on an object having a tubular core, and the tubular core is equipped with an RFID tag. The antenna supporter includes a securing portion and a non-metal surface. The securing portion is for fixing onto the machine. The non-metal surface is for supporting an antenna. The non-metal surface is spaced from the machine in a predetermined distance and disposed near an opening of the tubular core. An antenna assembly having the above-mentioned antenna supporter, and a machine having the antenna assembly are also provided.

### CROSS REFERENCE TO RELATED APPLICATION

The present application claims the benefit of priority to Taiwanese Patent Application No. 096132400, filed on Aug. 31, 2007, the disclosure of which is hereby incorporated herein by reference.

### BACKGROUND

1. Technical Field

The present invention generally relates to RFID technology, and more particularly to an antenna supporter, an antenna assembly and a machine having the antenna assembly.

2. Description of the Related Art

Nowadays, in order to facilitate production management, inventory control and track of paper rolls, RFID technology is employed in the production of the paper rolls such as U.S. Pub. No. 2004/0102870A1 entitled, “System and Method for Tracking Inventory”. However, electromagnetic waves are severely attenuated, resulting from that the electromagnetic waves must directly penetrate through the paper roll for communication. In another situation, when the RFID technology is employed in the production of the paper rolls, it is inevitable that the RFID reader antenna is installed on a metal surface of a paper roll machine. However, because the efficiency of the RFID reader antenna is susceptible to the metal, especially in the case of the RFID reader operating at an ultra high frequency (UHF, typically in the range of 850-960 MHz) band, which would result in the reading and written stability of the RFID tag seriously degraded and even cause failure of normally reading from and writing to the RFID tag.

What is needed is an antenna supporter, an antenna assembly and a machine having the antenna assembly, which could effectively address the above mentioned drawbacks.

### BRIEF SUMMARY

The present invention is to provide an antenna supporter for an antenna to be supported thereon. The antenna supporter is able to suppress an efficiency influence caused by a metal surface.

The present invention is also to provide an antenna assembly capable of suppressing an efficiency influence of an antenna thereon caused by a metal surface.

Furthermore, the present invention is to provide a machine having the antenna assembly.

An antenna supporter, in accordance with a present embodiment, is installed on a machine. The machine executes an operation on an object having a tubular core. The tubular core is equipped with an RFID tag. The antenna supporter includes a securing portion and a non-metal surface. The securing portion is configured for fixing onto the machine. The non-metal surface is configured for supporting an antenna. The non-metal surface is spaced from the machine in a predetermined distance and disposed near an opening of the tubular core.

Preferably, the machine may include a mechanical arm, the securing portion of the antenna supporter fixes onto the mechanical arm of the machine, and the non-metal surface is spaced from the mechanical arm in the predetermined distance.

Further preferably, the mechanical arm may include an inkjet device or a paper-rolling device, and the object is a paper roll.

In another aspect, an antenna assembly, in accordance with another present embodiment, is installed on a machine. The machine executes an operation on an object having a tubular core. The tubular core is equipped with an RFID tag. The antenna assembly includes an antenna supporter and an antenna. The antenna supporter includes a securing portion and a non-metal surface. The securing portion is configured for fixing onto the machine. The non-metal surface is spaced from the machine in a predetermined distance and disposed near an opening of the tubular core. The antenna is supported on the non-metal surface.

Preferably, the machine includes a mechanical arm. The securing portion of the antenna supporter is configured for fixing onto the mechanical arm of the machine, and the non-metal surface is spaced from the mechanical arm in the predetermined distance.

Further preferably, the mechanical arm includes an inkjet device or a paper-rolling device, and the object is a paper roll.

A machine, in accordance with still another present embodiment, executes an operation on an object having a tubular core. The tubular core is equipped with an RFID tag. The machine includes an antenna supporter, an antenna and a mechanical arm. The antenna supporter includes a securing portion and a non-metal surface. The securing portion is configured fixed on the mechanical arm. The non-metal surface is spaced from the mechanical arm in a predetermined distance and disposed near an opening of the tubular core. The antenna is supported on the non-metal surface.

Preferably, the mechanical arm includes an inkjet device or a paper-rolling device, and the object is a paper roll.

Compared with the related arts, the antenna is raised from the metal surface of the machine by the antenna supporter installed on the machine, and thus can be spaced away from the metal surface. Therefore, an efficiency influence of the antenna caused by the metal surface can be effectively suppressed.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, partial view of an inkjet machine, in accordance with a first embodiment, showing an antenna assembly being installed on a side surface of a mechanical arm of the inkjet machine and disposed near an RFID tag.

FIG. 2 is a schematic, perspective view of the antenna assembly installed on the inkjet machine of FIG. 1.

FIG. 3 is a schematic, exploded view of the antenna assembly of FIG. 2.

FIG. 4 is a schematic, partial view of an inkjet machine similar to that of FIG. 1, but showing the antenna assembly being installed on a top surface of the mechanical arm of the inkjet machine and disposed near the RFID tag.

FIG. 5 is a schematic, partial view of a paper-rolling machine, in accordance with a second embodiment.

FIG. 6 is a schematic, perspective view of an antenna assembly installed on the paper-rolling machine of FIG. 5.

FIG. 7 is a schematic, exploded view of the antenna assembly of FIG. 6.

FIG. 8 is a schematic, perspective view of another antenna assembly similar to the antenna assembly of FIG. 6, but showing the antenna is a patch antenna other than the dipole antenna.

### DETAILED DESCRIPTION

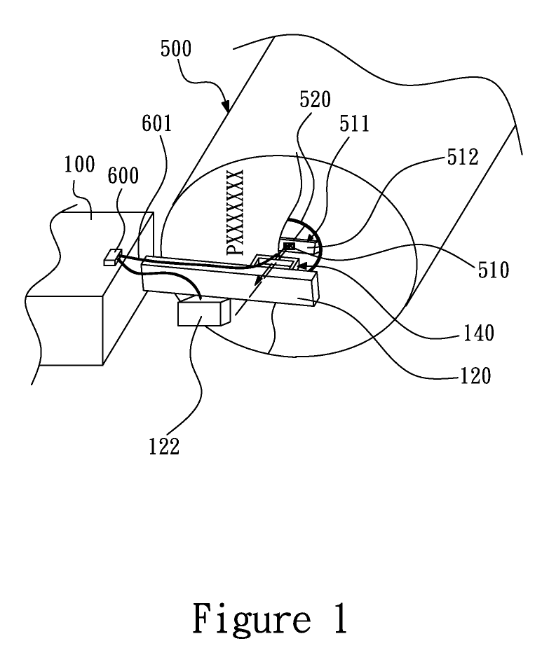

Referring to FIGS. 1-3, an inkjet machine 100, in accordance with a first embodiment, is provided. The inkjet machine 100 is to execute an inkjet printing operation toward a side surface of a paper roll 500, and the paper roll 500 is equipped with an RFID (Radio Frequency Identification) tag 510. The inkjet machine 100 includes a mechanical arm 120 and an antenna assembly 140.

In the illustrated embodiment, the paper roll 500 includes a tubular core 520. The RFID tag 510 may be fixed in any position of the tubular core 520. In particular, the RFID tag 510 can be directly adhered to an inner sidewall of the tubular core 520. Preferably, as illustrated in FIG. 1, the RFID tag 510 is fixed on a supporting member 511 which is fixed on a sidewall of tubular core 520. The supporting member 511 is beneficially made of a non-metal low K material, such as paper, plastic, polylone or sponge. The supporting member 511 includes a supporting portion 512. The supporting portion 512 has a carrier region, i.e., a region at which the RFID tag 510 is located for carrying the RFID tag 510. A normal vector, as indicated by the dashed arrow in FIG. 1, of the carrier region of the supporting portion 512 is substantially parallel to or forms a predetermined acute angle no more than 45 degrees with respect to an axial direction of the tubular core 520 as indicated by the dashed line in FIG. 1. Such an arrangement makes electromagnetic wave propagation directions of the RFID tag 510 be substantially accordant with the axial direction of the tubular core 520.

The mechanical arm 120 of the illustrated embodiment includes an inkjet device 122, which is to execute an inkjet printing operation toward a side surface of the paper roll 500.

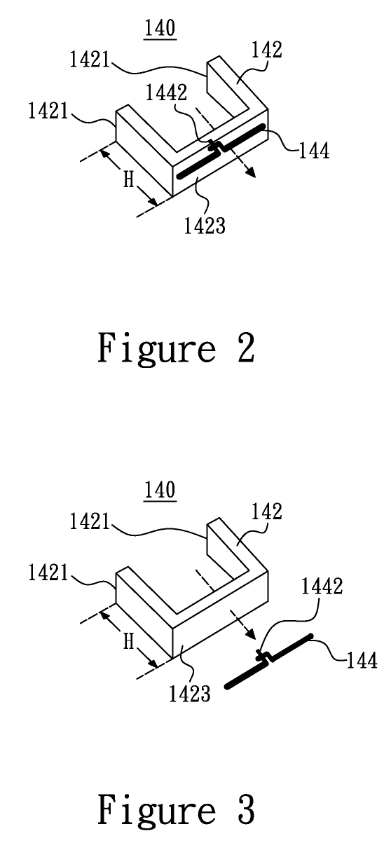

Referring to FIGS. 2 and 3, the antenna assembly 140 includes an antenna supporter 142 and an RFID reader antenna supported on the antenna supporter 142. In the illustrated embodiment, the RFID reader antenna is a dipole antenna 144.

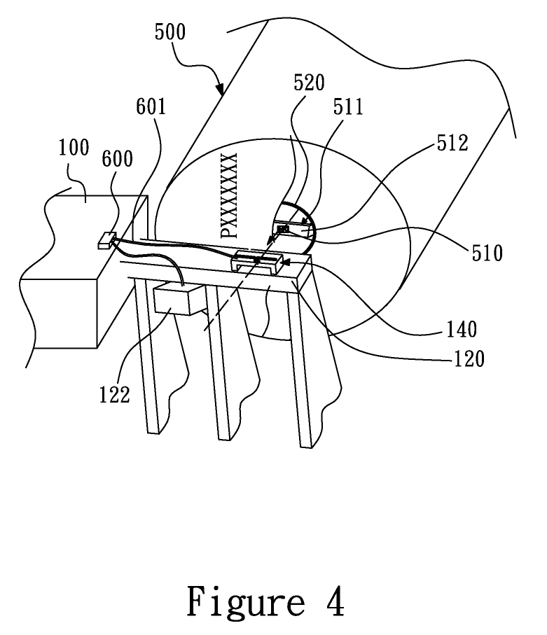

The antenna supporter 142 is disposed near an opening of the tubular core 520, allowing the electromagnetic waves generated from the RFID tag 510 to be received by the dipole antenna 144 or allowing information to be written in the RFID tag 510 by the dipole antenna 144. The antenna supporter 142 beneficially is made of paper, plastic, polylone, sponge or other non-metal low k materials. The antenna supporter 142 includes a securing portion 1421 and a non-metal surface 1423. The securing portion 1421 is configured for fixing onto the mechanical arm 120 of the inkjet machine 100. In particular, the securing portion 1421 can be fixed via a screw, glue, or other suitable means. The non-metal surface 1423 is disposed at a side surface of the mechanical arm 120 that is near the opening of the tubular core 520, i.e., near the RFID tag 510. A normal vector of the non-metal surface 1423, as indicated by the dashed arrows in FIGS. 2 and 3, is substantially parallel to an electromagnetic propagation direction of the RFID tag 510. In another embodiment, as illustrated in FIG. 4, the antenna assembly 140 can be fixed onto a top surface of the mechanical arm 120 that is near the RFID tag 510.

The non-metal surface 1423 is spaced from the mechanical arm 120 of the inkjet machine 100 in a predetermined distance H, so as to suppress an efficiency influence of the dipole antenna 144 caused by a metal surface of the mechanical arm 120. In the case of the dipole antenna 144 operating at an ultra high frequency (UHF, typically in the range of 850 MHz-960 MHz), the predetermined distance H is beneficially larger than or equal to 3 centimeters.

The dipole antenna 144 is supported on the non-metal surface 1423 of the antenna supporter 142. The dipole antenna 144 includes a radio frequency (RF) connector 1442, e.g., a SMA connector. The RF connector 1442 is configured for being connected with an RFID reader 600 via an RF cable 601. The dipole antenna 144 is typically a slim structure. A length L of the dipole antenna 144 approximately satisfies the equation: L=142.65/f, wherein the length of L has a unit of meter, f is an operating frequency of the dipole antenna 144 that has a unit of MHz. For the purpose of illustration, when f=950 MHz, the length L is approximately equal to 15 centimeters.

As illustrated in FIGS. 1-3, the antenna supporter 142 has a shape of an approximately [symbol] structure. The securing portion 1421 is the ends of two side surfaces of the [symbol] -shaped structure, and the non-metal surface 143 is a top surface of the [symbol] -shaped structure. The dipole antenna 144 is supported on the top surface of the [symbol] -shaped structure.

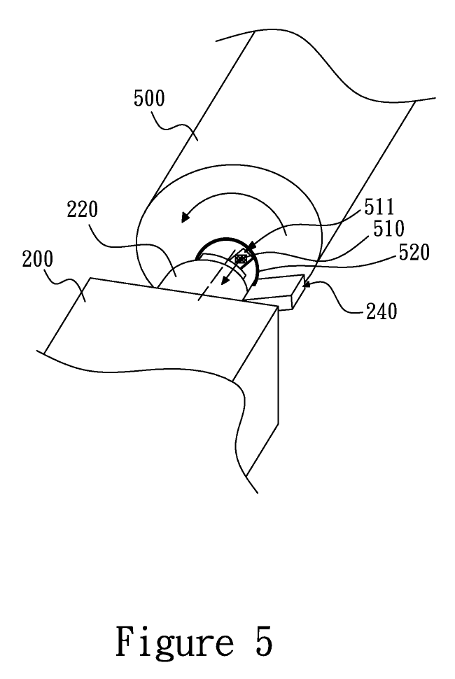

Referring to FIGS. 5-7, a paper-rolling machine 200, in accordance with a second embodiment, is provided. The paper-rolling machine 200 is to execute a rolling operation to a paper roll 500. The paper roll 500 is equipped with an RFID tag 510. The paper-rolling machine 200 includes a mechanical arm 220 and an antenna assembly 240.

In the illustrated embodiment, the paper roll 500 includes a tubular core 520. The RFID tag 510 is fixed in the tubular core 520. A manner of fixing the RFID tag 510 in the tubular core 520 is similar to that of the first embodiment, and thus will not be repeated herein.

The mechanical arm 220, associated with the illustrated embodiment, includes a paper-rolling device, which is to execute a rolling operation to the paper roll 500 as indicated by the curved arrow in FIG. 5.

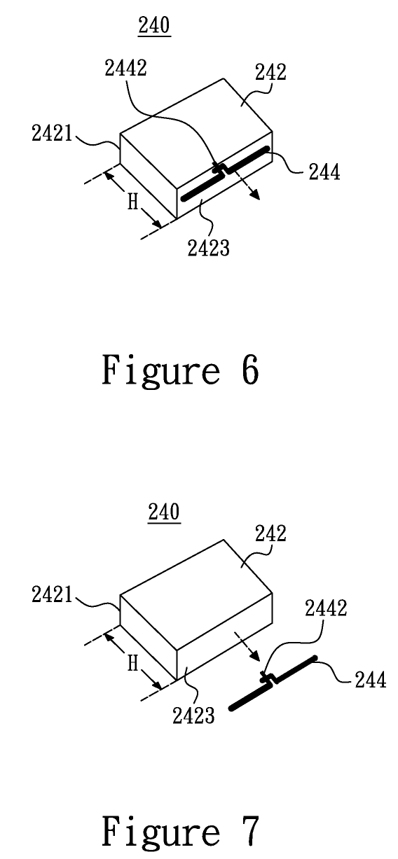

Referring to FIGS. 6 and 7, the antenna assembly 240 includes an antenna supporter 242 and an RFID reader antenna supported on the antenna supporter 242. In the illustrated embodiment, the RFID reader antenna is a dipole antenna 244.

In the illustrated embodiment, the antenna supporter 242 is disposed near an opening of the tubular core 520, allowing the electromagnetic waves generated from the RFID tag 510 to be received by the dipole antenna 244 or allowing information to be written in the RFID tag 510 by the dipole antenna 244. The antenna supporter 242 is beneficially made of paper, plastic, polyone, sponge or other non-metal low k materials. The antenna supporter 242 includes a securing portion 2421 and a non-metal surface 2423. The securing portion 2421 is fixed onto the mechanical arm 220 of the paper-rolling machine 200. In particular, the securing portion 2421 can be fixed onto the mechanical arm 220 via a screw, glue, or other suitable means. The non-metal surface 2423 is disposed at a position of the mechanical arm 220 that is near the RFID tag 5 10. As illustrated in FIG. 5, a normal vector of the non-metal surface 2423, as indicated by the dashed arrows in FIGS. 6 and 7, is substantially parallel to an electromagnetic propagation direction of the RFID tag 510. The non-metal surface 2423 is spaced from the paper-rolling machine 200 with a predetermined distance H, so as to suppress an efficiency influence of the dipole antenna 244 caused by a metal surface of the mechanical arm 220. In the case of the dipole antenna 244 operating at an ultra high frequency, the predetermined distance H is beneficially larger than or equal to 3 centimeters.

The dipole antenna 244 is supported on the non-metal surface 2423 of the antenna supporter 242. The dipole antenna 244 includes a radio frequency (RF) connector 2442, e.g., a SMA connector. The RF connector 2442 is configured for being connected with an RFID reader (not shown in FIG. 5). The dipole antenna 244 is typically a slim structure. A length L of the dipole antenna 244 approximately satisfies the equation: L=142.65/f, wherein the length L has a unit of meter, f is an operating frequency of the dipole antenna 144 that has a unit of MHz.

As illustrated in FIGS. 5-7, the antenna supporter 242 has a shape of an approximately strip or block structure. The securing portion 2421 is a side surface of the strip-shaped structure, and the non-metal surface 243 is a top surface of the strip-shaped structure. The dipole antenna 244 is supported on the top surface of the strip-shaped structure.

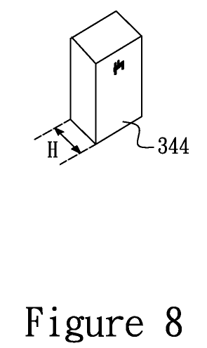

It is noted that the RFID reader antenna of the present invention is not limited to be the dipole antenna 244 of FIG. 6. For example, a patch antenna shown in FIG. 8 will do. As illustrated in FIG. 8, the patch antenna is assembled with a case 344. The thickness of the case 344 is the predetermined distance H. The case, e.g., also comprises a securing portion and a non-metal surface. The securing portion is the bottom surface of the case 344 configured to fix onto the mechanical arm. The non-metal surface is the top surface of the case disposed near an opening of the tubular core 520.

In conclusion, the antenna supporters 142, 242, associated with the first and the second embodiments, are employed to raise an RFID reader antenna from metal surfaces of machines 100, 200, so as to allow the RFID reader antenna to be spaced away from the metal surface. Therefore, an efficiency influence of the RFID reader antenna caused by the metal surface can be suppressed. In addition, the antenna of the present invention is disposed near the tubular core so that the waves of the antenna are easily to be directed toward the RFID tag fixed in the object.

Additionally, the antenna supporters 142, 242 associated with the first and the second embodiments are not limited to be [symbol] -shaped or strip-shaped, and may have other shapes suitable for raising the reader antenna from the metal surface, such as trapezoid, triangle, arc, and so on.

Furthermore, it is indicated that the antenna assembly of the present invention is not limited to be applicable to paper machines. In addition, the antenna of the present is not limited to a dipole antenna or a patch antenna.

The above description is given by way of example. Given the above disclosure, one skilled in the art could devise variations that are within the scope and spirit of the invention disclosed herein, comprising configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An antenna supporter installed on a machine, the machine executing an operation on an object, the object having a tubular core, the tubular core being equipped with an RFID tag therein, the antenna supporter comprising:
a securing portion for fixing onto the machine; and
a non-metal surface for supporting an antenna, the non-metal surface being spaced from the machine in a predetermined distance and disposed near an opening of the tubular core.

2. The antenna supporter according to claim 1, wherein the machine comprises a mechanical arm, the securing portion fixes onto the mechanical arm, and the non-metal surface is spaced from the mechanical arm in the predetermined distance.

3. The antenna supporter according to claim 2, wherein the mechanical arm comprises an inkjet device, the object is a paper roll, and the operation is to execute an inkjet printing toward a side surface of the paper roll.

4. The antenna supporter according to claim 2, wherein the mechanical arm comprises a paper-rolling device, the object is a paper roll, and the operation is to roll the paper roll.

5. The antenna supporter according to claim 1, wherein the predetermined distance is larger than or equal to 3 centimeters.

6. The antenna supporter according to claim 1, wherein the antenna supporter has a shape of an approximately [symbol] structure, the securing portion is adjoined with a side surface of the [symbol] structure, and the non-metal surface is a top surface of the [symbol] structure.

7. The antenna supporter according to claim 1, wherein the antenna supporter has a shape of an approximately strip structure, the securing portion is adjoined with a side surface of the strip-shaped structure, and the non-metal surface is a top surface of the strip-shaped structure.

8. An antenna assembly installed on a machine, the machine executing an operation on an object, the object having a tubular core, the tubular core being equipped with an RFID tag therein, the antenna assembly comprising:
an antenna supporter comprising a securing portion and a non-metal surface, the securing portion fixing onto the machine, the non-metal surface being spaced from the machine in a predetermined distance and disposed near an opening of the tubular core; and
an antenna supported on the non-metal surface.

9. The antenna assembly according to claim 8, wherein the machine comprises a mechanical arm, the securing portion fixes onto the mechanical arm, and the non-metal surface is spaced from the mechanical arm in the predetermined distance.

10. The antenna assembly according to claim 9, wherein the mechanical arm comprises an inkjet device, the object is a paper roll, and the operation is to execute an inkjet printing toward a side surface of the paper roll.

11. The antenna assembly according to claim 9, wherein the mechanical arm comprises a paper-rolling device, the object is a paper roll, and the operation is to roll the paper roll.

12. The antenna assembly according to claim 8, wherein the predetermined distance is larger than or equal to 3 centimeters.

13. The antenna assembly according to claim 8, wherein the antenna supporter has a shape of an approximately [symbol] structure, the securing portion is adjoined with a side surface of the [symbol] -shaped structure, and the non-metal surface is a top surface of the [symbol] -shaped structure.

14. The antenna assembly according to claim 8, wherein the antenna supporter has a shape of an approximately strip structure, the securing portion is adjoined with a side surface of the strip-shaped structure, and the non-metal surface is a top surface of the strip-shaped structure.

15. A machine for executing an operating on an object having a tubular core, the tubular core being equipped with an RFID tag therein, the machine comprising:
a mechanical arm;
an antenna supporter comprising a securing portion and a non-metal surface, the securing portion fixing onto the mechanical arm, the non-metal surface being spaced from the mechanical arm in a predetermined distance and disposed near an opening of the tubular core; and
an antenna supported on the non-metal surface.

16. The machine according to claim 15, wherein the mechanical arm comprises an inkjet device, the object is a paper roll, and the operation is to execute an inkjet printing toword a side surface of the paper roll.

17. The machine according to claim 15, wherein the mechanical arm comprises a paper-rolling device, the object is a paper roll, and the operation is to roll the paper roll.

18. The machine according to claim 15, wherein the antenna supporter has a shape of an approximately [symbol] structure, the securing portion is adjoined with a side surface of the [symbol] -shaped structure, and the non-metal surface is a top surface of the [symbol] -shaped structure.

19. The machine according to claim 15, wherein the antenna supporter has a shape of an approximately strip structure, the securing portion is adjoined with a side surface of the strip-shaped structure, and the non-metal surface is a top surface of the strip-shaped structure.

20. The machine according to claim 15, wherein the antenna is one of a dipole antenna and a patch antenna.
